(19) United States
(12) Patent Application Publication
(10) Pub. No.: US 2006/0021780 A1
(43) Pub. Date: Feb. 2, 2006

(54) Temporary outlet cover

(76) Inventor: Douglas C. Hill, Brook Park, OH (US)

Correspondence Address: Gregory S. Vickers, Esq.;Fay, Sharpe, Fagan, Minnich & McKee, LLP, Seventh Floor, 1100 Superior Avenue, Cleveland, OH, 44114-2579, US

(21) Appl. No.: 11/195,028

(22) Filed: Aug. 2, 2005

Related U.S. Application Data
(60) Provisional application No. 60/598,041, filed on Aug. 2, 2004.

(51) Int. Cl. H02G 3/14

(52) U.S. Cl. 174/67

(57) ABSTRACT

An outlet cover for temporarily covering an outlet box with an outlet installed in the outlet box. The box having a plurality of inwardly facing surfaces, a plurality of outside surfaces, and at least two mounting arrangements for securing the outlet thereto. The outlet including at least two elongated tabs for the securing of the outlet to the box wherein the tabs extend on either side of a plug receiver. The outlet cover including a face plate sized to at least substantially cover the plug receiver wherein the face plate has a front surface and an oppositely facing rear surface with a perimeter extending about the front surface. The cover further including a plurality of rearwardly extending friction tabs extending about a portion of the perimeter configured to extending between the outlet and the outlet box to frictionally engage at least one of the inwardly facing surfaces and retain the cover in a mounted position on the box such that the cover remains fixed relative to the box by the frictional engagement and the cover is spaced from the outside surface of the box.

This application claims priority in U.S. Provisional patent application Ser. No. 60/598,041 filed on Aug. 2, 2004.

The invention of this application relates to the art of electrical outlets and, more particularly, to covers that temporarily cover the outlet and the method of using the same.

### INCORPORATION BY REFERENCE

The present invention relates to temporary outlet covers for streamlining the process of installing outlets and working around the outlets after installation. In addition, outlet covers according to the present invention allow the outlet box to be preassembled off-site for further reductions in the time required to wire buildings, including medical facilities. Oliver et al. U.S. Pat. No. 6,166,329; and Petak et al. U.S. Pat. No. 6,653,566 disclose temporary outlet covers and a method of using the outlet covers. These patents are incorporated by reference herein as background information illustrating temporary outlet covers. Erdfarb U.S. Pat. No. 6,103,974; Compagnone, Jr. U.S. Pat. No.6,686,540; Thompson U.S. Pat. No. 5,432,298; Loscuito U.S. Pat. No. 4,953,733; Sullivan U.S. Pat. No. 6,520,363; Morgan et al. U.S. Pat. No. 6,403,883; Stuchlik III U.S. Pat. No. 4,907,711; Sullivan U.S. Pat. No. 2002/0102308; Holsinger U.S. Pat. No. 3,059,803; Mohr U.S. Pat. No. 2,775,812; Weiting U.S. Pat. No. 4,202,388; Shaffer et al. U.S. Pat. No. 6,538,202; Jordan et al. U.S. Pat. No. 5,562,222; Smith U.S. Pat. No. 5,902,960; Neuman U.S. Pat. No. 6,076,696; Schuette U.S. Pat. No. 5,639,991; Green U.S. Pat. No. 5,526,952; disclose various types of outlet covers and are also incorporated by reference herein as background information.

### BACKGROUND OF THE INVENTION

The present invention is particularly applicable for use in connection with commercial installation of outlets and, therefore, the invention will be described with particular reference to commercial installations. However, the invention has broader applications and may be used with virtually any type of outlet and in any facility.

It is, of course, well known that outlet covers can be used in connection with the installation of outlets to prevent the joint compound and/or other debris from entering the empty outlet box during the taping of the wallboard and other finishing work. It is also known that the outlet cover can be positioned over the electrical outlet that is installed in the outlet box to prevent the joint compound from damaging the outlet.

However, prior art outlet covers can be difficult to install and remove and can require the power to the outlet to be turned off to prevent an electrical short and/or a code violation. Further, while some prior art outlet covers provide marking features for helping locate the outlet for cutting the outlet opening, they can interfere with the tools used to cut the opening. In this respect, it has been found that rotary cutting tools, such as the ROTO ZIP tool from the Roto Zip Tool Corporation, can be used to quickly cut the outlet openings. The prior art outlet covers can interfere with the use of this type of tool and can be damaged or destroyed if the rotating bit of the tool comes in contact with the outlet cover.

### SUMMARY OF THE INVENTION

In accordance with the present invention, provided is a temporary outlet cover that can be placed over a wired outlet in an outlet box and which is spaced from the outlet in the box to allow the electrical power to the outlet to be on. Further, the outlet cover fits within side walls of the outlet box to prevent the cover from interfering with the use of a rotary cutting tool to cut the outlet opening.

In accordance with another aspect of the present invention, provided is an outlet cover, and a method of using the outlet cover, for temporarily covering an outlet box with an outlet installed in the outlet box. The box having a plurality of inwardly facing surfaces, a plurality of outside surfaces, and at least two mounting arrangements for securing the outlet thereto. The outlet including at least two elongated tabs for the securing of the outlet to the box wherein the tabs extend on either side of a plug receiver. The outlet cover including a face plate sized to at least substantially cover the plug receiver wherein the face plate has a front surface and an oppositely facing rear surface with a perimeter extending about the front surface. The cover further including a plurality of rearwardly extending friction tabs extending about a portion of the perimeter configured to extending between the outlet and the outlet box to frictionally engage at least one of the inwardly facing surfaces and retain the cover in a mounted position on the box such that the cover remains fixed relative to the box by the frictional engagement, and the cover is spaced from the outside surface of the box.

### BRIEF DESCRIPTION OF THE DRAWINGS

The foregoing, and more, will in part be obvious and in part be pointed out more fully hereinafter in connection with a written description of preferred embodiments of the present invention illustrated in the accompanying drawings in which:

FIG. 1 is an exploded front perspective view of a temporary outlet cover according to an aspect of the present invention and an outlet box;

FIG. 2 is a bottom view of the outlet cover shown in FIG. 1;

FIG. 3 is a right side elevational view of the outlet cover shown in FIG. 1;

FIG. 4 is a back side view of the outlet cover shown in FIG. 1;

FIG. 5 is a perspective view of the outlet cover shown in FIG. 1 wherein the outlet cover is positioned over the outlet box, but slightly pulled away from a mounted position;

FIG. 6 is a perspective view of the outlet cover shown in FIG. 5 wherein the outlet cover is in the mounted position; and, FIG. 7 is a perspective view of a dual outlet cover according to another aspect of the present invention and a dual outlet box.

### DESCRIPTION OF PREFERRED EMBODIMENTS

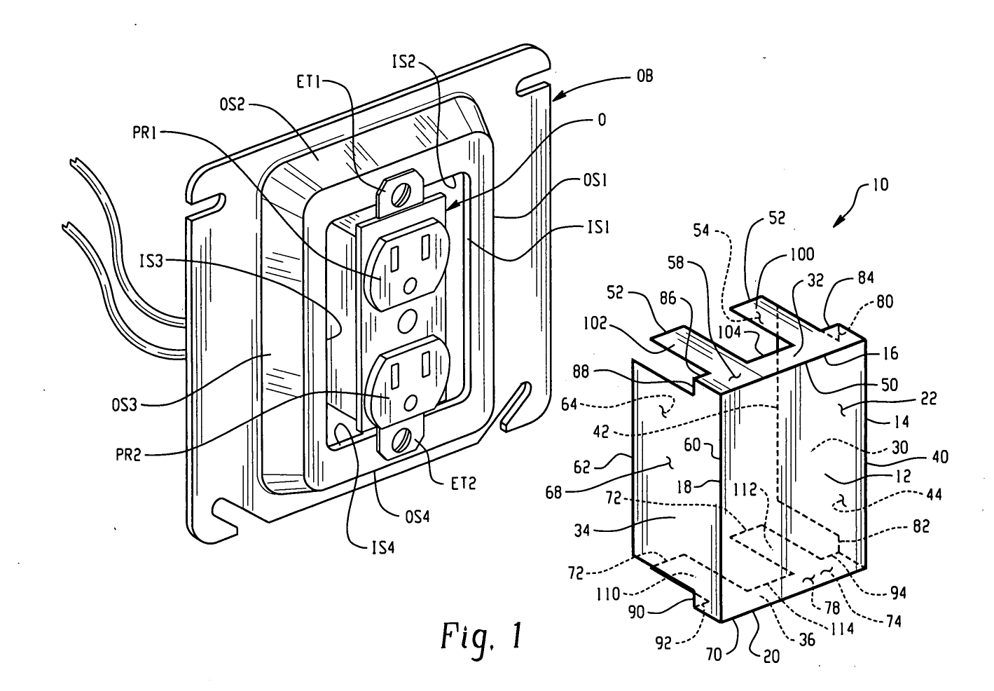

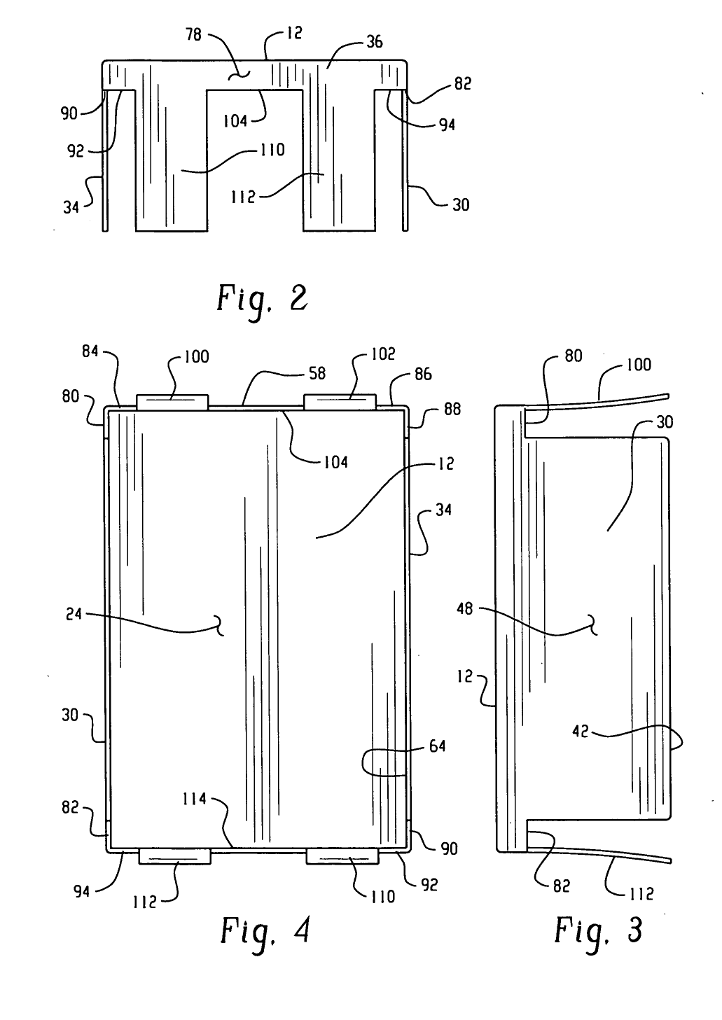

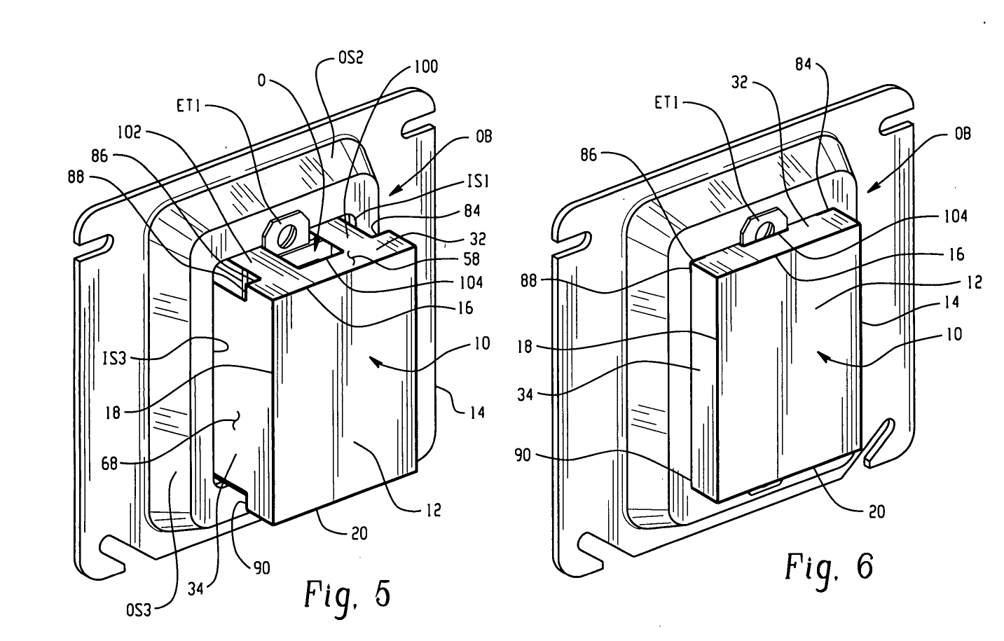

Referring now in greater detail to the drawings wherein the showings are for the purpose of illustrating preferred embodiments of the invention only, and not for the purpose of limiting the invention, FIGS. 1-6 illustrate a temporary outlet cover 10 used to cover an outlet box OB for a single outlet O. The outlet cover can be made from any known material including, but not limited to, metal and plastic wherein the cover is durable and reusable. Further, the cover can be made from less expensive materials, such as from paper products, to allow the product to be sold with a preassembled outlet assembly wherein the cover is discarded after a single use.

Cover 10 includes a face plate 12 having perimeter edges 14, 16, 18 and 20. Face plate 12 further includes a front surface 22 and a rear surface 24. Cover 10 further includes rearwardly extending prongs or tabs that are shaped and configured to engage an inner surface of outlet box OB and/or outlet O. In this respect, cover 10 includes tabs 30, 32, 34 and 36. The rearward tabs or prongs are configured to engage either the inner side walls of the outlet box or the side edges of the front cover opening of the outlet box if a front plate box is used. As is stated above, the invention of this application is being described in relation to commercial outlet boxes, however, the cover can be used in connection with residential outlet boxes or any other outlet box known in the art.

In greater detail, the tabs are spaced from one another at least partially based on the size and configuration of the outlet box. As will be discussed in greater detail below, the tabs can also be sized and configured in relation to the outlet used in the outlet box. Tab 30 can be configured to frictionally engage outlet box surface IS1, tab 32 can be configured to frictionally engage outlet box surface IS2, tab 34 can be configured to frictionally engage outlet box surface IS3, and/or tab 36 can be configured to frictionally engage outlet box surface IS4. By including tabs that frictionally engage inner surfaces of outlet box OB, a gap is produced between cover 10 and outer sides OS1, OS2, OS3 and OS4 wherein the cover does not interfere with a rotary tool when the outlet box opening is cut.

Tab 30 extends from a base 40 adjacent to edge 14 to a distal end 42. Tab 30 further includes an inner surface 44 and an outer surface 48. Tab 32 extends from a base 50 adjacent to edge 16 to a distal end 52. Tab 32 further includes an inner surface 54 and an outer surface 58. Tab 34 extends from a base 60 adjacent to edge 18 to a distal end 62. Tab 34 further includes an inner surface 64 and an outer surface 68. Tab 36 extends from a base 70 adjacent to edge 20 to a distal end 72. Tab 36 further includes an inner surface 74 and an outer surface 78.

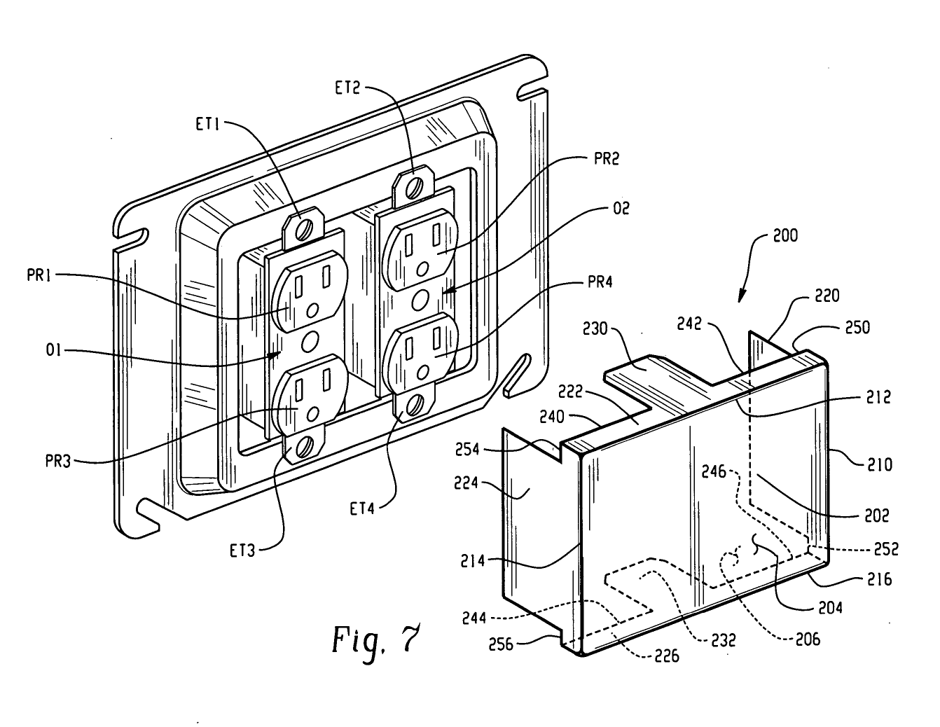

The cover is maintained on the outlet box by the frictional engagement of the tabs and at least one inner surface of the outlet box. In this respect, one or more of the tabs can be configured to frictionally engage one or more of the inner surfaces of the outlet box. As can be appreciated, any number of the tabs can include the frictional engaging features while other tabs can have purely positioning uses. As is shown, outer surface 48 of tab 30 can frictionally engage inner surface IS1, outer surface 58 of tab 32 can frictionally engage inner surface IS2, outer surface 68 of tab 34 can frictionally engage inner surface IS3 and/or outer surface 78 of tab 36 can frictionally engage inner surface IS4. The frictional engagement between the tabs and the inner surfaces of the outlet box maintain cover 10 relative to box OB in a mounted position which is shown in FIG. 6. By utilizing frictional engagement, tools are not needed to install and/or remove the outlet cover from the outlet.

The outlet cover can further include one or more stops to space face plate 12 from plug receivers PR1 and PR2. In this respect, the rearward extending tabs can further include a perimeter stop or ridge to help control the mounting position of the cover relative to the outlet box. This can be used to space the face plate from the plug receivers or even to provide grabbing points to help the end-user remove the cover from the box. In this respect, tab 30 can include stop portions 80 and 82, tab 32 can include stop portions 84 and 86, tab 34 can include stop portions 88 and 90, and tab 36 can include stop portions 92 and 94. The cover can also include a perimeter ridge (not shown) configured to engage a portion of the outlet and/or outlet box to help maintain the cover at a desired position on the outlet box. As a result, while the cover fits within the perimeter of the outlet box, which prevents interference with the tools used to cut the outlet opening, the cover is spaced from the electronics of the outlet, namely the plug receivers, to allow the power to the outlet to be turned on before the cover is removed.

The cover can also include stops that are configured to engage one or both of elongated tabs or connection plates ET1 and ET2 of outlet O to maintain the desired spacing between the outlet cover and the outlet. As is stated above, by maintaining a spacing between the cover and the plug receivers the outlet can be turned on even before the cover is removed. In greater detail, tab 32 can be a U-shaped tab with a leg 100 and a leg 102 spaced from leg 100 wherein one or both of the legs can be friction legs used to help maintain the cover relative to the outlet. The spacing of the legs can be spaced to allow the legs to pass on either side of elongated tab ET1 when the cover is in the mounted position. Tab 32 can further include a stop 104 between the legs to engage the outlet to produce the desired spacing between the cover and the outlet. The stop can engage elongated tab ET1 or other portions of the outlet to produce the spacing. Similarly, tab 36 can also be a U-shaped tab with a leg 110 and a leg 112 spaced from leg 110 wherein one or both of the legs can be friction legs used to help maintain the cover relative to the outlet. The spacing of the legs can be spaced to allow the legs to pass on either side of elongated tab ET2 when the cover is in the mounted position. Tab 36 can further include a stop 114 between the legs to engage the outlet to produce the desire spacing between the cover and the outlet. The stop can engage elongated tab ET2 or other portions of the outlet to produce the spacing.

While the cover according to the present invention can be used on outlet boxes already installed in a home or business, the cover can also be used in connection with preassembled outlet boxes. In this respect, outlet boxes can be fully wired before assembly including fully wiring the box off-site. Once an outlet box is fully wired, the outlet box can be installed in the facility to be wired. The outlet and outlet box can include quick-connect electrical connections known in the art (not shown) to reduce the time necessary to wire the box to the facility. As can be appreciated, the invention of this application can be used in connection with a wide variety of electrical boxes, electrical devices and connectors and is not limited to single and double outlets.

Then, the cover is positioned on the assembled outlet box by aligning the top tabs, bottom tabs and/or side tabs between the outlet and outlet box opening. As discussed above, the top and bottom tabs can include a pair of legs that are positioned on either side of the outlet's connection plates that are used to secure the outlet to the box. Again, as can also be appreciated, while the invention of this application is being described with respect to commercial outlet boxes that include a front plate, this invention can be practiced in connection with other style outlet boxes. Once the tabs are in proper alignment between the front plate opening and the outlet, the cover is pushed onto the assembled outlet box until one or more of the stops of the cover engages at least one of the outlet connection plates and/or the outlet box. By engaging the connection plates and/or the outlet box, the cover is spaced from the front of the electrical outlet and, thus, the electrical connectors or plug receivers allow the power to the electrical box to be turned on before the cover is removed.

FIG. 7 illustrates yet another embodiment, namely, a temporary outlet cover 200 similar to the covers described above. This embodiment is for an outlet box for a double outlet. Further, while not shown, the invention of this application can be used on outlet boxes with more than two outlets without detracting from the invention of this application. Outlet cover 200 includes a face plate 202 sized and configured to at least substantially cover the four plug receivers PR1, PR2, PR3 and PR4. Face plate 202 includes an outside surface 204 and an inside surface 206 with perimeter edges 210, 212, 214 and 216 extending about the face plate. As with any embodiment of this application, the perimeter edges do not need to be well defined or sharp. In this respect, the edges can be smoothly rounded edges or can include any edge configuration known in the art. As is shown in this embodiment, edges 210, 212, 214 and 216 are rounded. Cover 200 further includes backwardly extending tabs 220, 222, 224 and/or 226 extending from edges 210, 212, 214 and 216, respectively. In this embodiment, tabs 222 and 226 can be T-shaped tabs with central legs 230 and 232, respectively, that can be frictional legs to maintain the cover in the mounted position. Tabs 222 and 226 can further include stops to maintain a desired spacing between inside surface 206 of the face plate and the plug receivers. In this respect, tab 222 can include stops 240 and/or 242 configured to engage elongated tabs or connection plates ET1 and ET2 of outlet O1 and O2, respectively. As can be appreciated, as with the other embodiments, the stops can engage other portions of the outlets, such as a surface between the connection plates and plug receivers. Further, as will be discussed in greater detail below, the stops can engage other portions of the outlets and/or outlet box. Similarly, tab 226 can include stops 244 and/or 246 configured to engage elongated tabs or connection plates ET3 and ET4 of outlet O1 and O2, respectively. By including stops, cover 200 can be easily pressed into a desired position by simply aligning the tabs between the outlets and the outlet box and pressing the cover onto the outlet box. The stop will control the desired spacing between the face plate and the electronics of the box.

As is stated above, the cover can include tabs 220 and 224 which are side tabs that are vertically extending tabs in most outlet applications. These side tabs can be used to create additional frictional engagement to secure the cover and/or to further align the cover relative to the outlet and the outlet box. In this respect, tabs 220 and 224 can frictionally engage an inner surface of the outlet box such as, but not limited to, the inner side edges of the face plate opening of the outlet box. As with the embodiments discussed above, this configuration creates a cover that securely stays in place on the outlet box without interfering with the work performed about the outlet box such as using a rotary tool to cut the box opening in the wallboard. Tab 220 can include stops 250 and 252 which are at or near the top and bottom edges of the tab, and tab 224 can include stops 254 and 256 which are at or near the top and bottom edges of the tab. These stops can function to produce the desired gap between the cover and the outlets and/or can be used in connection with the stops on tabs 222 and 226 to produce the desire gap. As with all embodiments in this application, the tabs and stops can include lead-in tapers, such is shown on legs 230 and 232, at their distal end to aid in the aligning of the cover between the outlet and the outlet box. Further, any lead-in configuration could be used.

In operation, the cover is positioned on the assembled outlet box in similar fashion as described above with respect to cover 10. In this respect, side tabs 220 and 224 are aligned between the box opening and the respective sides of the outlet while legs 230 and 232 are aligned between the connection plates of the outlets and within the opening of the outlet box. Once aligned, the cover is pushed onto the outlet box until the stops engage the outlets and/or the outlet box.

Again, the invention of this application has been found to work particularly well in connection with commercial applications and, therefore, the invention has been described with particular reference to commercial applications. But the invention of this application is not to be limited to commercial applications, in that it can be used on a wide variety of outlet boxes. Depending on the configuration of the box, the rearward tabs are configured to engage either the inner side walls of the outlet box or the side edges of the front cover opening of the outlet box if a front plate outlet box is used.

Again, the invention of this application can also be used in different ways including, but not limited to, preassembling an outlet box with the cover before the outlet box is assembled at the facility in which it will be used. Conversely, the cover can be used in connection with an outlet box already assembled at the facility. Further, the outlet box can use any known technology, such as quick-connect electrical connectors or standard connectors, etc., without detracting from the invention of this application. As can be appreciated, using quick-connect connectors can save time, especially when utilizing the preassembled technique in accordance with the invention of this application.

In a further embodiment of the present invention, the covers can include markings. In this respect, multi-colored covers can be used, so that different types of assemblies can be easily distinguishable. For example, a green cover can be used for outlets that are medical grade outlets, while red covers can be used for standard commercial applications. Other colors can be used for virtually any other distinguishing features of the outlet, such as for outlets with ground fault interrupts or outlets with different types of electrical connectors. Further, other distinguishing marks could also be used to distinguish one outlet or electrical device from another device. These other distinguishing marks can include number codes, letter codes, colored dots or any other coding system known in the art. Yet even further, the covers can include sales and/or marketing materials to be presented to the consumer. In one example, the cover can be used as a point of sale sheet for preassembled outlet boxes sold to the consumer in the preassembled form. As can be appreciated, the preassembled box could be on a store shelf, such that the cover according to the present invention includes sales information including, but not limited to, trademarks and installation instructions. As can also be appreciated, covers sold in this fashion could be disposable covers made from inexpensive material, such as inexpensive plastics and/or paper products or even a combination of materials.

In yet another embodiment, one or more of the tabs are shaped to increase the frictional engagement with the outlet box. In this respect, one or more of the tabs could be arcuate, curving outwardly from the face plate, to increase the frictional engagement with the corresponding inner surface of the outlet box. In another embodiment (not shown), one or more of the tabs could be wavy and/or include a thickened portion to increase the frictional engagement of the tab. In yet another embodiment (not shown), the legs and/or tabs could include differing thicknesses to help the frictional engagement between the cover and the outlet and/or outlet box. While the drawings of this application show uniform wall thicknesses for the different portions of the cover, this is only for description purposes wherein the cover can include portions of differing thickness without detracting from the invention of this application.

As discussed above, in one embodiment, the outlet covers are preassembled off-site so that mass production techniques can be used to install the outlet in the outlet box. In this respect, an outlet can be screwed to the outlet box off-site using assembly jigs or fixtures in connection with mass production power tools that are designed to reduce the assembly time. For example, overhanging power tools with screw feeders can be used to install the outlet screws to the outlet box. Further, easy grasp part containers can be ergonomically placed in the work station to assist the operator and reduce the time necessary for the assembly process. By creating an ergonomic work station, the assembler can utilize both hands to preassemble the outlet to the box and the front cover to the box. As can be appreciated, such assembly techniques are not possible at the job site. Any known assembly technique can thus be used to quickly attach the outlet to the outlet box. Further, outlets with commercially available quick-connect electrical connections can also be used to reduce the job site time for the installation of the outlet. By utilizing the covers according to the present invention, the preassembled outlet box can be fully protected between the preassembly site and the facility in which the outlet is being installed. These techniques can be used to produce outlet boxes to be sold as an assembled unit and/or can be used by the end user to reduce the time necessary to wire a facility.

As can be appreciated, while only single and double outlet box configurations are shown, the invention of this application can be used in connection with other outlet boxes without detracting from the invention of this application.

While considerable emphasis has been placed on the preferred embodiments of the invention illustrated and described herein, it will be appreciated that other embodiments can be made and that many changes can be made in the preferred embodiments, including equivalents thereof, without departing from the principles of the invention. Accordingly, it is to be distinctly understood that the foregoing descriptive matter is to be interpreted merely as illustrative of the invention and not as a limitation.

Having thus defined the invention, the following is claimed:

1. An outlet cover for temporarily covering an outlet box with an outlet installed in the outlet box, the box having a plurality of inwardly facing surfaces, a plurality of outside surfaces, and at least two mounting arrangements for securing the outlet thereto, the outlet including at least two elongated tabs for the securing of the outlet to the box wherein the tabs extend on either side of a plug receiver, said outlet cover comprising a face plate sized to at least substantially cover the plug receiver, said face plate having a front surface and an oppositely facing rear surface with a perimeter extending about said front surface; a plurality of rearwardly extending friction tabs extending about a portion of said perimeter configured to extending between the outlet and the outlet box to frictionally engage at least one of said inwardly facing surfaces and retain said cover in a mounted position on the box such that said cover remains fixed relative to said box by said frictional engagement and said cover is spaced from the outside surface of the box.

2. The outlet cover according to claim 1, further including a stop spaced from said face plate, said stop engaging one of the at least two elongated tabs on the outlet such said rear surface of said face plate is spaced from said plug receiver when said cover is in said mounted position.

3. The outlet cover according to claim 2, wherein said plurality of friction tabs includes a top tab and a bottom tab, one of said top and bottom tabs including said stop.

4. The outlet cover according to claim 2, wherein said plurality of friction tabs includes a top tab and a bottom tab and said stop includes a top stop and a bottom stop, said top tab including said top stop and said bottom tab including said bottom stop.

5. The outlet cover according to claim 4, wherein said top tab and said bottom tab are U-shaped, said top tab including two top frictional legs spaced from one another to extend on either side of a corresponding one of the elongated tabs of the outlet when in said mounted position, said top stop extending between said two top frictional legs and forming the web of said U-shape, said bottom tab including two bottom frictional legs spaced from one another to extend on either side of a corresponding one of the elongated tabs of the outlet when in said mounted position, said bottom stop extending between said two bottom frictional legs and forming the web of said U-shape.

6. The outlet cover according to claim 1, further including a stop spaced from said face plate, said stop engaging the outlet such that said rear surface of said face plate is spaced from said plug receiver when said cover is in said mounted position.

7. The outlet cover according to claim 1, wherein the outlet box is a commercial outlet box which includes a face plate having an outlet opening, the plurality of inwardly facing surfaces being the edges of the outlet opening, said plurality of rearwardly extending friction tabs engaging said edge.

8. The outlet cover according to claim 2, wherein said plurality of friction tabs includes a top tab, a bottom tab, a first side tab and a second side tab, one of said top and bottom tabs including said stop.

9. The outlet cover according to claim 1, wherein said plurality of friction tabs includes a top tab, a bottom tab, a first side tab and a second side tab, said cover further including a stop spaced from said face plate, said stop engaging one of the outlet and the outlet box such said rear surface of said face plate is spaced from said plug receiver when said cover is in said mounted position.

10. A method of temporarily covering an outlet box while work is being done about the outlet box wherein an outlet is already installed in the outlet box, the outlet box having a plurality of inwardly facing surfaces, a plurality of outside surfaces, and at least two mounting arrangements for securing the outlet thereto, the outlet including at least two elongated tabs for the securing of the outlet to the box wherein the tabs extend on either side of a plug receiver, said method including the steps of:
providing an outlet cover comprising a face plate sized to at least substantially cover the plug receiver, said face plate having a front surface and an oppositely facing rear surface with a perimeter extending about said front surface, said cover further including a plurality of rearwardly extending friction tabs extending about a portion of said perimeter;
positioning said cover on the outlet box which includes an installed outlet such that said plurality of tabs extends between the outlet and the outlet box and frictionally engages at least one of the inwardly facing surfaces of the outlet box to retain said cover in a mounted position on the outlet box such that said cover remains fixed relative to said box by said frictional engagement and said cover is spaced from the outside surface of the box.

11. The method according to claim 10 further including the steps of providing a preassembled outlet including the outlet box and the outlet assembled together before said providing of said cover step and installing the preassembled outlet and said cover after said positioning step.
